(19) United States
(12) Patent Application Publication
(10) Pub. No.: US 2014/0010615 A1
(43) Pub. Date: Jan. 9, 2014

(54) LOW TORQUE NUT

(71) Applicant: Kinichi KAWAKAMI, Tokyo (JP)

(72) Inventor: Kinichi KAWAKAMI, Tokyo (JP)

(21) Appl. No.: 13/544,299

(22) Filed: Jul. 9, 2012

(51) Int. Cl. F16B 39/28

(52) U.S. Cl. 411/167

(57) ABSTRACT

A low torque nut is capable of easily generating a large axial force by a small torque to fasten and has stable anti-loosening qualities. The low torque nut includes a nut member having a screwed runner, an engagement portion, and plural screwed runners drilled from an outer periphery plane toward an inner diameter direction. The low torque nut also includes a ring-shaped saucer member rotatably mounted in a lower portion of the nut member, plural rolling elements that lie within a contact portion in an axial direction between the nut member and the saucer member, and a locking member that has an engagement groove being engaged with a spline groove and an inserting hole of a screw threadedly connecting to the screwed runner of the nut member.

### BACKGROUND OF THE INVENTION

1. Field of the Invention

The present invention relates to a low torque nut used as a means for connecting and fixing of respective portions such as various mechanical devices, building structures, pipes or the like.

2. Description of the Related Art

Heretofore, a nut is tightened to a bolt connecting to parts of mechanical devices and steel frames of building structures, and connections between the parts or members are realized by the tightening. However, when vibrations and shocks are applied to these parts or members, a fastening force between the bolt and the nut becomes progressively weaker, hence, this is a concerned matter among those skilled persons in the art.

Therefore, as an improved nut for preventing loosening of such a fastened nut, for example, a fastener described in Japanese Patent Application Laid-open No. H9-280239 (Patent Document 1) is known.

This nut is comprised of a lower nut and an upper nut that a screwed runner (tapped hole) is formed in through-hole, a convex portion having a tapered outer periphery plane that tapers in around of the screwed runner in outward of an axial direction, is formed on the lower nut, and the outer periphery plane of the convex portion has a minute eccentricity with respect to the screwed runner. On the other hand, a concave portion that is engaged with the convex portion of the lower nut, is formed on the upper nut, and an inner periphery plane of the concave portion is concentric with the screwed runner. In this way, since the convex portion and the concave portion have eccentricity, in tightening the upper nut and the lower nut, the nut overlaps into a diameter direction with respect to a shaft center of the screwed runner respectively, and a large stress in the diameter direction acts on a screw axis. In the nut disclosed in Patent Document 1, by a wedge effect brought by the upper nut and the lower nut, preventing the loosening of the fastened nut.

However, the main purpose of the above-described nut of Patent Document 1 is to effectively prevent the loosening of the nut in tightening to the bolt, and the nut of Patent Document 1 is not aimed at generating a large axial force with respect to the bolt and at fastening and fixing the nut. Therefore, it is impossible to apply a double nut such as the nut disclosed in Patent Document 1 to connecting portions that fastening and fixing caused by a large axial force is required such as a primary system valve of a nuclear power plant, an electric power turbine, a feed-water pump, a compressor, support pillars of building structures, a large-size construction machine, a tower crane and so on.

On the other hand, in a fastening means based on a normal bolt and a normal nut, in the case of performing tightening and loosening of those normal bolt and nut by using a torque wrench, a friction resistance occurring at a contact seat surface (mainly a flange plane of the connecting portion) of a tightening object, reaches at about 50% of a generated torque. As a result, particularly, in the case that the bolt has a large diameter, there is a problem that due to this large friction resistance, the tightening object does not elude damage of the contact seat surface. Moreover, with respect to a screw-surface friction resistance occurring between the rotating nut and a screw portion of the bolt, if the lubricant state is bad, the torque of up to 40% is consumed. As a result, there is a problem that the torque effectively acting as an axial force becomes only about 10% of the total generated torque.

As described above, in a tightening and loosening work using a torque wrench that is one of methods that generate an axial force with respect to the bolt, rotating the bolt and the nut by a tightening torque to generate the axial force with respect to the bolt. Generally, within an elastic region of the bolt, the torque and the axial force are in direct proportion to each other. Although the axial force generated in accordance with the increasing of the torque also increases, friction resistances necessarily occur in this process. As described above, one of the friction resistances is a screw surface friction force occurring in a screw slide portion of the bolt and the nut. It is possible to reduce this screw surface friction force by applying an antifriction and penetration material, or, a lubricant containing molybdenum or copper dusts to the slide portion.

However, by using the conventional nut, it is impossible to avoid the seat surface friction force occurring between the nut plane and the seat surface of the tightening object, and it is a concerned matter that the axial force and the torque efficiency remarkably degrade due to the seat surface friction force. Further, a trouble that due to the seat surface friction force, particularly, in loosening, a frictional heat is generated between screw planes, a weld phenomenon occurs and then the nut does not rotate, also occurs.

### THE LIST OF PRIOR ART DOCUMENT

Patent Document 1: Japanese Patent Application Laid-open No. H9-280239

### SUMMARY OF THE INVENTION

The present invention has been developed in view of the above-described circumstances, and an object of the present invention is to provide a low torque nut that is capable of easily generating a large axial force by a small torque to fasten and realizing a stable anti-loosening with a high reliability.

The above-described object of the present invention is achieved by that a low torque nut that is mounted to a thread groove of a bolt connecting to a tightening object, comprising: a nut member that a screwed runner threadedly connecting to said thread groove is formed on an inner periphery plane, a predetermined shape engagement portion for being engaged with a tightening tool is formed on a top surface, and a plurality of position fixing screwed runners are drilled from an outer periphery plane toward an inner diameter direction; a ring-shaped saucer member being rotatably mounted in a lower portion of said nut member that a non-slip plane is formed on a bottom in contact with said tightening object, and position fixing spline grooves are formed on an outer periphery plane along an axial direction at equal angle intervals; a plurality of rolling elements that lie within a contact portion in an axial direction between said nut member and said saucer member; and a locking member that has an engagement groove being engaged with said spline groove and a screw inserting hole that a screw threadedly connecting to said position fixing screwed runner of said nut member is inserted into, wherein said locking member is fixed to said position fixing screwed runner of said nut member by said screw in a state of engaging said engagement groove with said spline groove after said nut member is fastened.

Further, the above-described object of the present invention is more effectively achieved by that wherein said position fixing screwed runner is drilled in at least four places along said outer periphery plane of said nut member at equal angle intervals.

On the other hand, the above-described object of the present invention is achieved by that a low torque nut that is mounted to a thread groove of a bolt connecting to a tightening object, comprising: a nut member that a screwed runner threadedly connecting to said thread groove is formed on an inner periphery plane, a predetermined shape engagement portion for being engaged with a tightening tool is formed on a top surface, and an external thread groove in a direction opposite to said thread groove is formed on an outer periphery plane; a ring-shaped saucer member being rotatably mounted in a lower portion of said nut member that a non-slip plane is formed on a bottom in contact with said tightening object, and position fixing spline grooves are formed on an outer periphery plane along an axial direction at equal angle intervals; a plurality of rolling elements that lie within a contact portion in an axial direction between said nut member and said saucer member; a ring-shaped nut-side sleeve member that an internal thread groove threadedly connecting to said external thread groove is formed on an inner periphery plane; and a ring-shaped saucer-side sleeve member having a same height as said saucer member and a same outer diameter as said nut-side sleeve member that an engagement groove being engaged with said spline groove is formed on an inner periphery plane, wherein after said nut member is fastened, said saucer-side sleeve member is mounted on said saucer member in a state of engaging said engagement groove with said spline groove, and said internal thread groove of said nut-side sleeve member is threadedly connected to said external thread groove, said nut-side sleeve member is tightened until a bottom of said nut-side sleeve member takes a seat at a top surface of said saucer-side sleeve member.

The above-described object of the present invention is more effectively achieved by that wherein thread connection between said external thread groove of said nut member and said internal thread groove of said nut-side sleeve member is in a direction opposite to thread connection between said thread groove of said bolt and said screwed runner of said nut member.

Moreover, the above-described object of the present invention is more effectively achieved by that wherein said nut member is provided with a lubricant injection hole that is drilled to said screwed runner of an inner periphery plane in a radial direction from an outer surface.

The above-described object of the present invention is more effectively achieved by that wherein said nut member is provided with a plurality of lubricant injection holes that are drilled to said screwed runner of an inner periphery plane in a radial direction from an outer surface, and said plural lubricant injection holes are set to a difference angle each other with respect to said inner periphery plane respectively.

Further, the above-described object of the present invention is more effectively achieved by that wherein said rolling elements are disposed within a concave groove formed on a top surface of said saucer member along a circumferential direction.

Further, the above-described object of the present invention is more effectively achieved by that wherein said rolling elements are comprised of a plurality of rollers with a conic trapezoidal shape and a plurality of steel spheres with a spherical shape that are disposed in each gap between said plurality of rollers.

Further, the above-described object of the present invention is more effectively achieved by that wherein said rolling elements are a plurality of rollers with a conic trapezoidal shape.

Still further, the above-described object of the present invention is more effectively achieved by that wherein said rolling elements are a plurality of steel spheres with a spherical shape.

### BRIEF DESCRIPTION OF THE DRAWINGS

In the accompanying drawings:

FIG. 1 is a side view showing a state that a low torque nut according to a first embodiment of the present invention is fastened to a bolt;

FIG. 2 is a front view showing the low torque nut according to the first embodiment of the present invention;

FIG. 3 is a top view showing the low torque nut according to the first embodiment of the present invention;

FIGS. 4A and 4B are sectional views showing the low torque nut according to the first embodiment of the present invention;

FIG. 5 is a bottom view showing the low torque nut according to the first embodiment of the present invention;

FIG. 6 is a front view showing a locking member according to the first embodiment of the present invention;

FIGS. 7A, 7B and 7C are sectional views showing substantial parts of a nut member according to the first embodiment of the present invention;

FIGS. 8A and 8B are sectional views showing a main part of a low torque nut according to a first variation of the first embodiment of the present invention;

FIGS. 9A and 9B are sectional views showing a main part of a low torque nut according to a second variation of the first embodiment of the present invention;

FIG. 10 is a front view showing a low torque nut according to a second embodiment of the present invention;

FIG. 11 is a top view showing the low torque nut according to the second embodiment of the present invention;

FIGS. 12A and 12B are sectional views showing the low torque nut according to the second embodiment of the present invention;

FIG. 13 is a bottom view showing the low torque nut according to the second embodiment of the present invention;

FIG. 14 is a top view showing a nut-side sleeve member according to the second embodiment of the present invention; and

FIG. 15 is a top view showing a saucer-side sleeve member according to the second embodiment of the present invention.

### MODE FOR CARRYING OUT THE INVENTION

Hereinafter, a first embodiment of a low torque nut according to the present invention will be described with reference to the accompanying drawings.

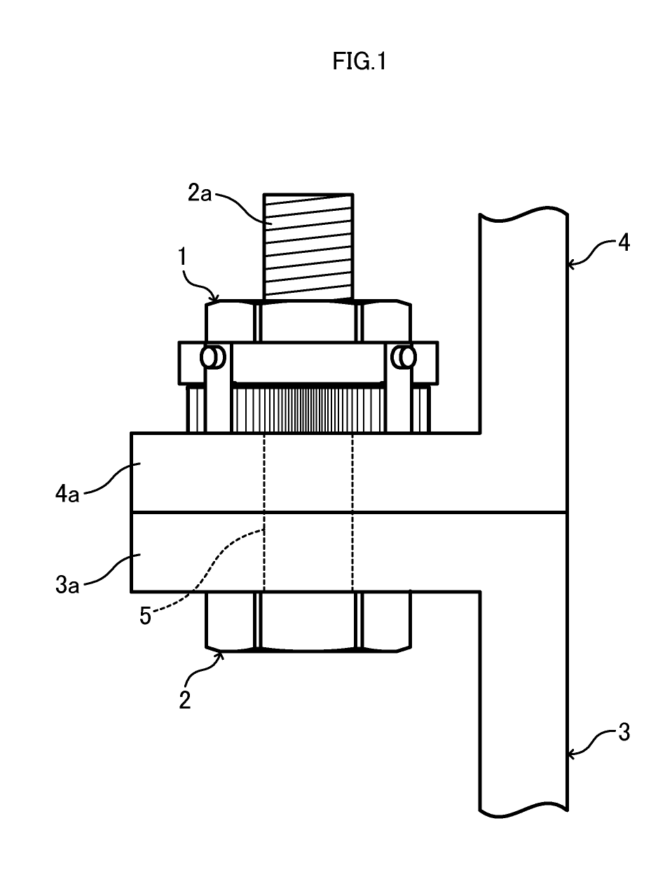

FIG. 1 is a side view showing a state that the low torque nut according to the first embodiment of the present invention is fastened to a bolt. As shown in FIG. 1, the low torque nut 1 according to the first embodiment is used as a connection and fixing means of various joint portions of engines, motors, arm portions of construction machineries, pipes, support pillars of building structures or the like, and is fixed in a screw portion (thread groove) 2a of a bolt 2. The bolt 2 is inserted into a bolt inserting hole 5 respectively drilled in flange portions 3a and 4a of tightening objects 3 and 4, and two tightening objects 3 and 4 are connected and fixed by the low torque nut 1 being threadedly connected to a screw portion 2a that penetrates the flange portions 3a and 4a through the bolt inserting hole 5.

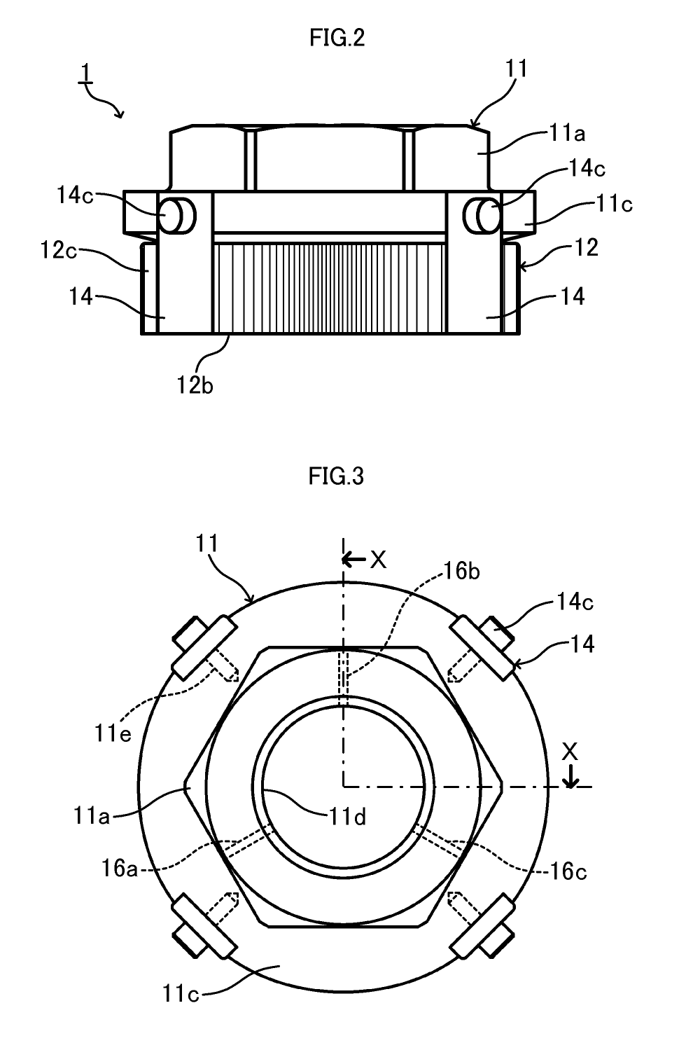

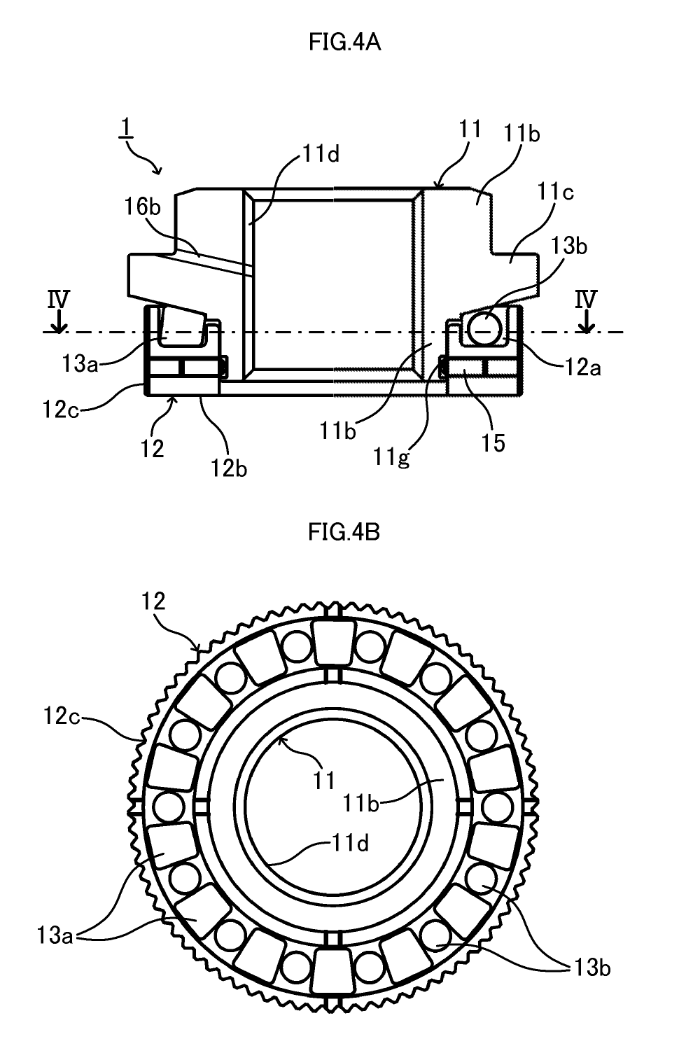

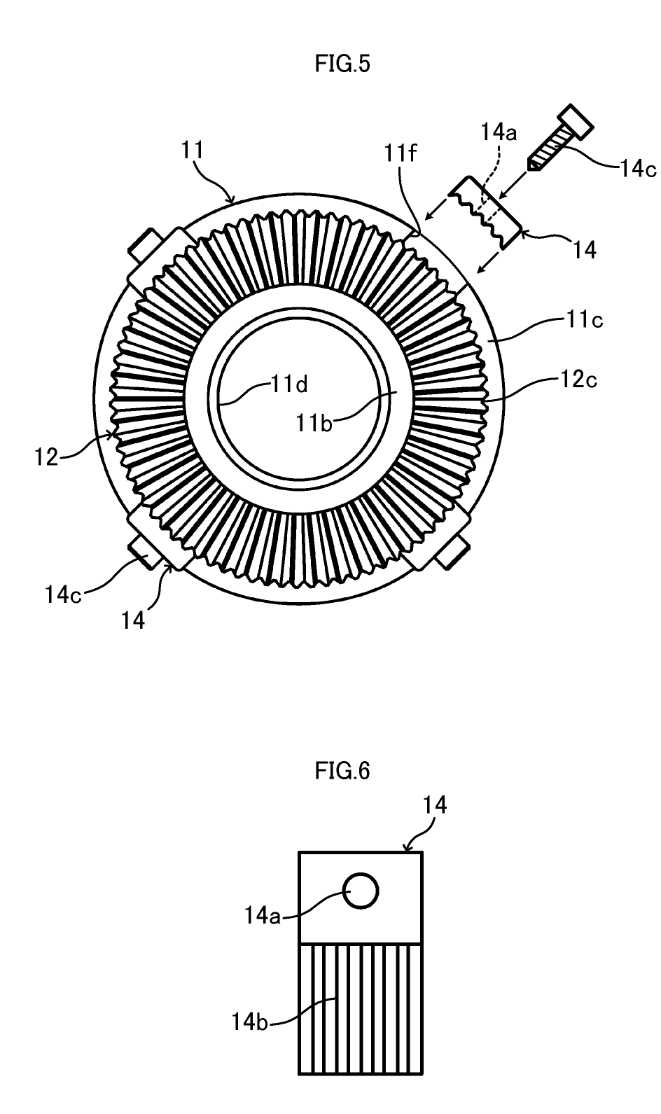

FIG. 2 is a front view showing the low torque nut 1 according to the first embodiment of the present invention, and FIG. 3 is a top view thereof. Further, FIG. 4A is a fragmentary sectional view taken along the line X-X in FIG. 3, and FIG. 4B is a fragmentary sectional view taken along the line VI-VI in FIG. 4A. Moreover, FIG. 5 is a bottom view showing the low torque nut according to the first embodiment of the present invention.

As shown in FIGS. 2, 3, 4A and 4B, the low torque nut 1 comprises a hollow nut member 11 that a regular hexagonal engagement portion 11a for being engaged with a tightening tool (such as a torque wrench) is formed thereon and a ring-shaped saucer member 12 that is rotatably mounted so as to surround a lower cylinder portion 11b of the nut member 11. A plurality of rolling elements 13a and 13b lie between a top surface of the saucer member 12 and a flange portion 11c of the nut member 11 facing the top surface of the saucer member 12 along a circumferential direction, and the nut member 11 and the saucer member 12 are fixed by a plurality of locking members 14 so as not to rotate in the circumferential direction. All of the nut member 11, the saucer member 12, each of the rolling elements 13a and 13b and the locking members 14 are comprised of metal materials that have intensities capable of sufficiently meeting fixing of the high intensity bolt 2.

A screwed runner 11d that threadedly connects to the thread groove (the screw portion) 2a of the bolt 2 is formed on an inner periphery plane of the nut member 11, and a position fixing screwed runner 11e is drilled in an outer periphery plane of the nut member 11 toward an inner diameter at an predetermined angle interval (in the first embodiment of the present invention, at every 90° interval). A keyway 11f corresponding to the shape of the locking member 14 is formed in the vicinity of the position fixing screwed runner 11e along an axial direction. Further, a groove 11g is formed on an outer periphery plane of the lower cylinder portion 11b of the nut member 11 along the circumferential direction, and the saucer member 12 is rotatably connected to the circumference of the lower cylinder portion 11b by inserting a ball plunger 15 that is inserted through the saucer member 12 into the groove 11g.

The saucer member 12 is provided with a concave groove 12a having a U (Japanese character “ [symbol] ”)-shaped cross-section that is formed thereon with an upper-side opening along the circumferential direction, and the above-described plural rolling elements 13a and 13b intervene in the concave groove 12a. On the other hand, a bottom 12b of the saucer member 12 which is a portion that the low torque nut 1 contacts with the flange portion 4a of the tightening object 4, is a non-slip plane with a high frictional resistance formed by knurling applied to a surface or the like of a clutch plate so as not to rotate and move a contact surface of the flange portion 4a when a torque is generated. Further, position fixing spline grooves 12c are formed on an outer periphery plane of the saucer member 12 along the axial direction at equal angle intervals. These spline grooves 12c act as a serration that is capable of finely adjusting angle phase of combination with the locking member 14 described below in detail.

The rolling elements within the concave groove 12a of the saucer member 12 are comprised of a plurality of rollers 13a that are disposed along the circumferential direction so that its bottom turns to an outer diameter direction and have respective conic trapezoidal shapes, and a plurality of steel spheres 13b that are disposed in each gap between the plural rollers 13a and have respective spherical shapes. The size of the steel sphere 13b in a height direction is smaller than the size of the roller 13a in the height direction, respectively. Accordingly, when the torque is generated, the rolling elements contacting with both the nut member 11 and the saucer member 12 are only the rollers 13a, and the steel spheres 13b serve as a shock-absorbing material for realizing a smooth rotation. Further, a surface of the flange portion 11c of the nut member 11 facing these rolling elements 13a and 13b, is formed in the form of an umbrella to deal with contact with the rollers 13a.

FIG. 6 is a front view showing the locking member 14 according to the first embodiment of the present invention. As shown in FIG. 6, a screw inserting hole 14a that a screw 14c with a washer threadedly connecting to the position fixing threaded screw hole 11e of the nut member 11 is inserted into, is drilled in an upper portion of the locking member 14, and engagement grooves 14b corresponding to the spline grooves 12c of the saucer member 12 are formed in a lower portion of the locking member 14. With respect to the locking member 14, after the nut member 11 is fastened to the bolt 2, in a state that the engagement grooves 14b are engaged with the spline grooves 12c of the saucer member 12, the screw 14c is inserted into the screw inserting hole 14a and the screw 14c is fastened to the position fixing screwed runner 11e. Then, the locking member 14 is fixed to the nut member 11. In this way, the locking member 14 functions as a whirl-stop, and the nut member 11 fastened to the bolt 2 and the saucer member 12 do not rotate with respect to the bolt 2.

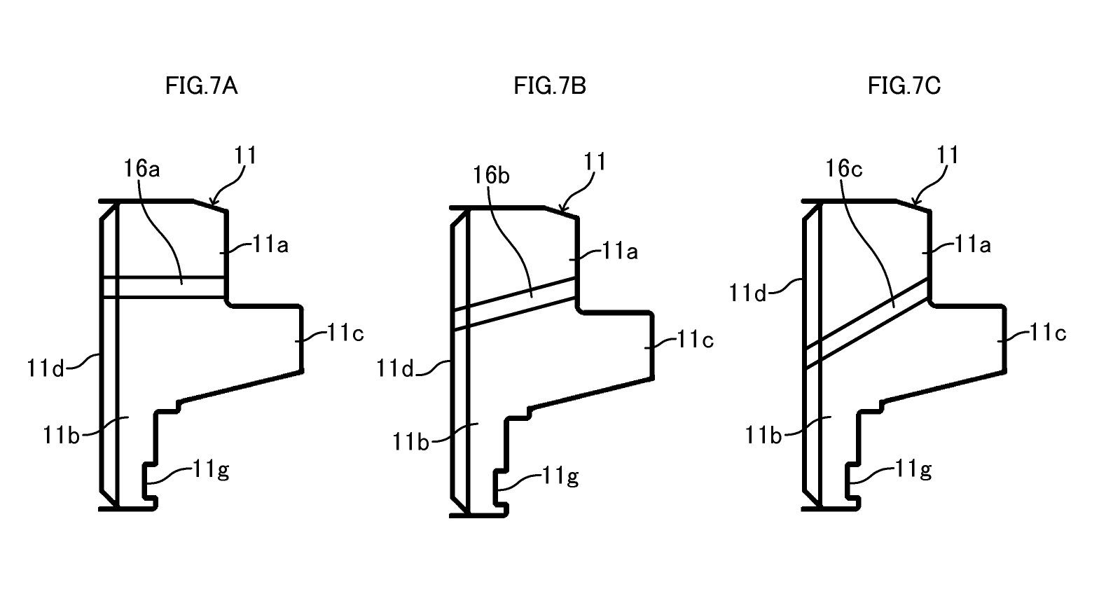

Further, as shown in FIG. 3, the nut member 11 is provided with a plurality of lubricant injection holes 16a, 16b and 16c that are drilled to the screwed runner 11d of the inner periphery plane in a radial direction from the outer surface. FIGS. 7A, 7B and 7C are sectional views showing main parts of the nut member along the lubricant injection holes 16a, 16b and 16c, respectively. These three lubricant injection holes 16a, 16b and 16c are set to a difference angle each other with respect to the inner periphery plane (the screwed runner) 11d, respectively. Concretely, the lubricant injection hole 16a is set perpendicularly with respect to the inner periphery plane 11d, the lubricant injection hole 16b is set so as to incline upward at an angle 15° from a plane perpendicular to the inner periphery plane 11d, and the lubricant injection hole 16c is set so as to incline upward at an angle 30° from the plane perpendicular to the inner periphery plane 11d. During an operation that loosens the low torque nut 1 tightened to the bolt 2 after aging, in the case that a friction of a contact plane between the screw groove 2a of the bolt 2 and the screwed runner 11d of the nut member 11 is large, the lubricant injection holes 16a, 16b and 16c are pathways for penetrating a screw contact portion with lubricants (such as penetrants) for reducing the friction.

In such a case, heretofore, the lubricating effects of the screw contact portion are realized by breathing the penetrant on a head of the nut with. However, in the first embodiment of the present invention, since it is possible to certainly penetrate the screw contact portion with the lubricant through the lubricant injection holes 16a, 16b and 16c, it is possible to considerably improve the lubricating effects of the screw contact portion than ever before. Further, in the first embodiment, since the plural lubricant injection holes 16a, 16b and 16c are provided to a difference angle each other with respect to the inner periphery plane (the screwed runner) 11d, it is possible to extensively spread the lubricant to an axial direction of the screw contact portion.

When tightening the low torque nut 1 according to the first embodiment, at first, threadedly connecting the screwed runner 11d of the nut member 11 to the thread groove 2a of the bolt 2 and then manually turning in until the low torque nut 1 takes a seat, i.e. the bottom 12b of the saucer member 12 comes in contact with the surface of the flange portion 4a of the tightening object 4. Next, tightening the nut member 11 up to a predetermined torque, a predetermined axial force and a predetermined angle by using a tightening tool such as a manual operation or a hydraulic torque wrench. After the completion of this tightening operation, in order to prevent a return rotation, fixing the locking member 14 to at least one or more places of the position fixing screwed runner 11e and the keyway 11f through the screw 14c.

On the other hand, when loosening the low torque nut 1 according to the first embodiment, at first, loosening the screw 14c fixing the locking member 14 to release an anti-rotation. Next, loosening the nut member 11 by using the tightening tool such as the manual operation or the hydraulic torque wrench. In this case, in the case that a friction of a contact face between the thread groove 2a and the screwed runner 11d is large due to the aging, the nut member 11 is loosed after injecting the lubricants through the lubricant injection holes 16a, 16b and 16c.

As described above, in the low torque nut 1 according to the first embodiment, the nut member 11 that a rotation torque is given through the tightening tool, does not directly contact with the tightening object 4, and the saucer member 12 that is rotatably fixed to the nut member 11 through the rolling elements 13a and 13b, contacts with the seat surface of the flange portion 4a. As a result, since it is possible to considerably reduce a necessary torque for tightening and loosening as compared to the conventional nuts, it is possible to realize a speed-up and a laborsaving of the tightening and the loosening works, and further it is possible to make a great improvement even in a safety aspect. On the other hand, even in loosening the low torque nut 1 according to the first embodiment, since the nut member 11 is a rotatable structure without contacting with the seat surface of the flange portion 4a, it is possible to quickly carry out works without damaging the seat surface of the flange portion 4a.

Further, in the low torque nut 1 according to the first embodiment, threadedly fixing the locking member 14 in a state of engaging the locking member 14 with the spline groove 12c formed on the outer periphery plane of the saucer member 12 so that the nut member 11 does not rotate after fastening the nut member 11 to the bolt 2. As a result, since it is possible to prevent the return rotation (i.e. loosening rotation) of nut caused by vibrations and so on, it is possible to realize improvement of reliability.

Moreover, in the low torque nut 1 according to the first embodiment, since the position fixing screwed runner 11e and the keyway 11f that are a fixing portion of the locking member 14, are provided in the circumferential direction of the nut member 11 at the angle 90° interval, even in the case of fixing to the flange portion 4a of the tightening object 4 as shown in FIG. 1, it is possible to fix at least two locking members 14 to the nut member 11. That is to say, since it is possible to secure at least two places of the position fixing screwed runner 11e and the keyway 11f that screw fixation is not disturbed by the tightening object 4, it is possible to realize the stable anti-loosening.

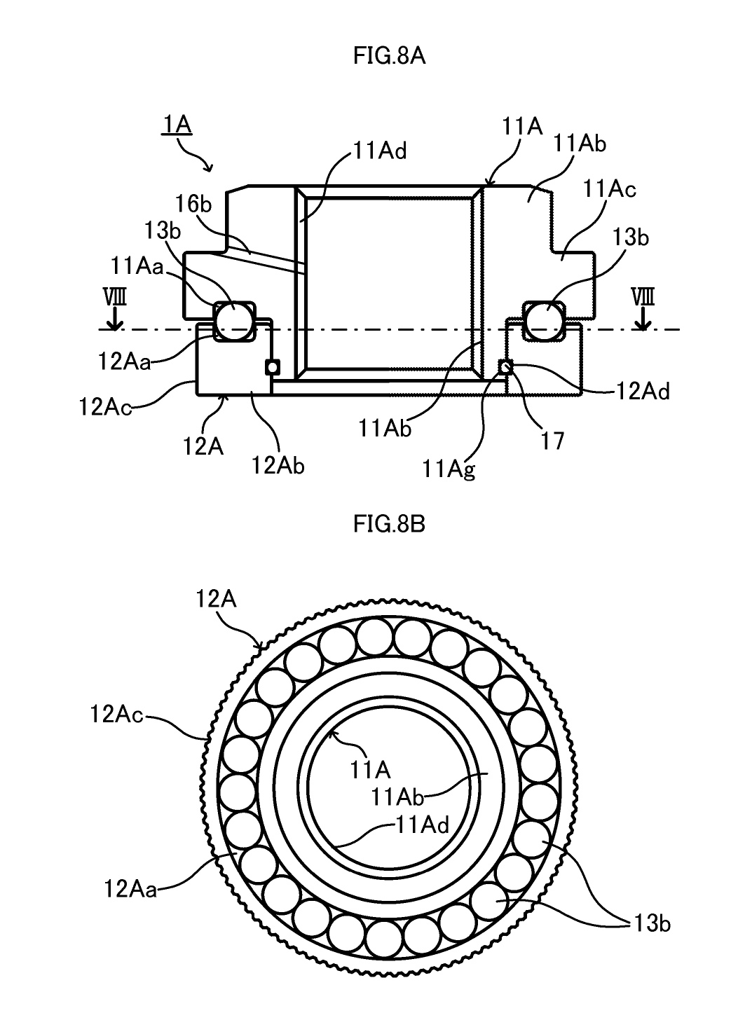

FIGS. 8A and 8B are sectional views showing main parts of a low torque nut 1A according to a first variation of the first embodiment of the present invention. Concretely, FIG. 8A is a fragmentary sectional view taken along the line X-X in FIG. 3, and FIG. 8B is a fragmentary sectional view taken along the line VIII-VIII in FIG. 8A. Moreover, in FIGS. 8A and 8B, with respect to members that are the same as the above-described first embodiment, identical reference numerals (symbols) are given without adding explanations.

As shown in FIG. 8A, in the low torque nut 1A according to the first variation of the first embodiment, a groove 11Ag is formed on an outer periphery plane of a lower cylinder portion 11Ab of a nut member 11A along the circumferential direction, a groove 12Ad that is the same as the groove 11Ag, is formed on an inner periphery plane of a saucer member 12A facing the groove 11Ag, and an O-ring 17 lies within a space demarcated by the groove 11Ag and the groove 12Ad. Therefore, the nut member 11A and the saucer member 12A are rotatably connected through the O-ring 17.

Further, as shown in FIG. 8B, in the low torque nut 1A according to the first variation, all of rolling elements that function as a contact portion in the axial direction between the nut member 11A and the saucer member 12A, are steel spheres 13b. In the above-described first embodiment, the surface of the flange portion 11c of the nut member 11 facing the rolling elements 13a and 13b, is formed in the form of an umbrella to deal with contact with the rollers 13a. However, in the first variation, a surface of a flange portion 11Ac of the nut member 11A facing the rolling elements 13b is a horizontal plane, and a concave groove 11Ah that is the same as a concave groove 12Aa of the saucer member 12A in the horizontal plane, is formed on a portion facing the concave groove 12Aa. The steel spheres 13b that are the rolling elements, are disposed within a ring-shaped space divided by the concave groove 11Ah of the nut member 11A and the concave groove 12Aa of the saucer member 12A.

According to the low torque nut 1A relating to the first variation of the first embodiment that is comprised of such a structure, it is possible to obtain operations, functions and effects that are the same as the above-described first embodiment.

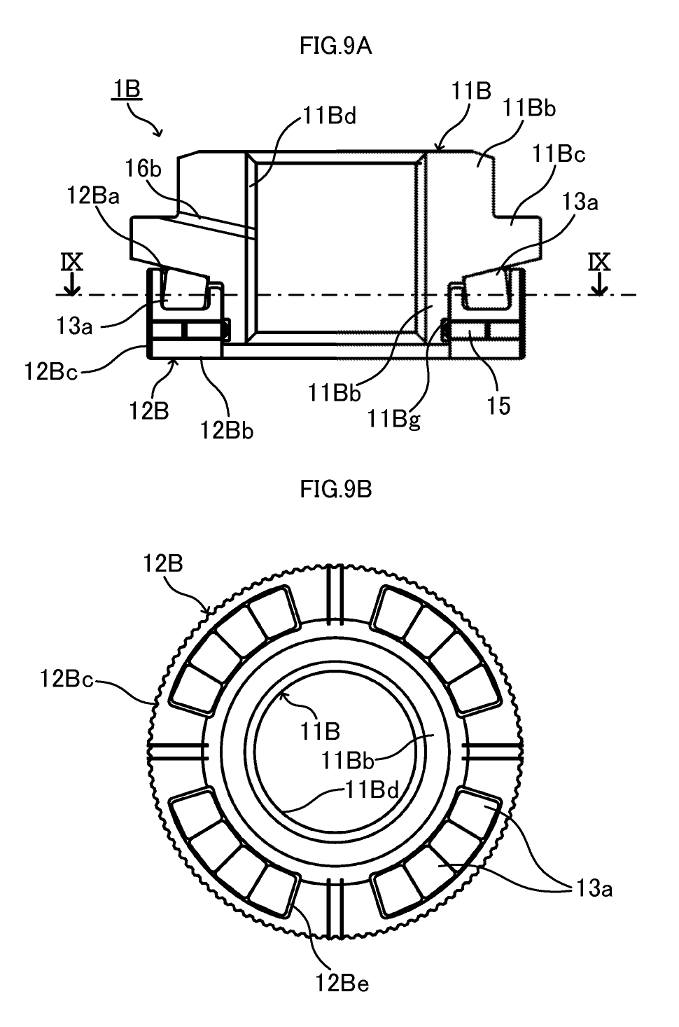

FIGS. 9A and 9B are sectional views showing main parts of a low torque nut 1B according to a second variation of the first embodiment of the present invention. Concretely, FIG. 9A is a fragmentary sectional view taken along the line X-X in FIG. 3, and FIG. 9B is a fragmentary sectional view taken along the line IX-IX in FIG. 9A. Moreover, in FIGS. 9A and 9B, with respect to members that are the same as the above-described first embodiment, identical reference numerals (symbols) are given without adding explanations.

As shown in FIGS. 9A and 9B, in the low torque nut 1B according to the second variation of the first embodiment, all of rolling elements that function as a contact portion in the axial direction between a nut member 11B and a saucer member 12B, are a plurality of rollers 13a that have a conic trapezoidal shape. A plurality of pockets 12Be are formed on the upper surface of the saucer member 12Ba along the circumferential direction at an angle 90° interval, and four rollers 13a are housed in each pocket 12Be.

According to the low torque nut 1B relating to the second variation of the first embodiment that is comprised of such a structure, it is possible to obtain operations, functions and effects that are the same as the above-described first embodiment.

Hereinafter, a second embodiment of a low torque nut according to the present invention will be described with reference to the accompanying drawings. Moreover, in the second embodiment, with respect to members that are the same as the above-described first embodiment, identical reference numerals (symbols) are given without adding explanations.

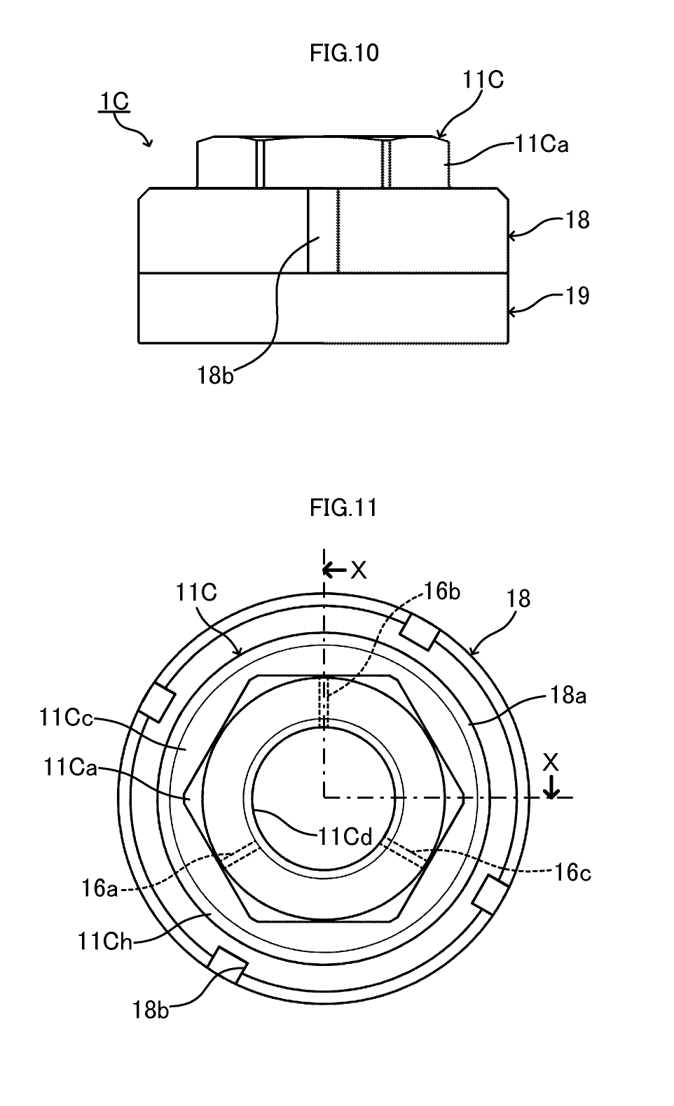

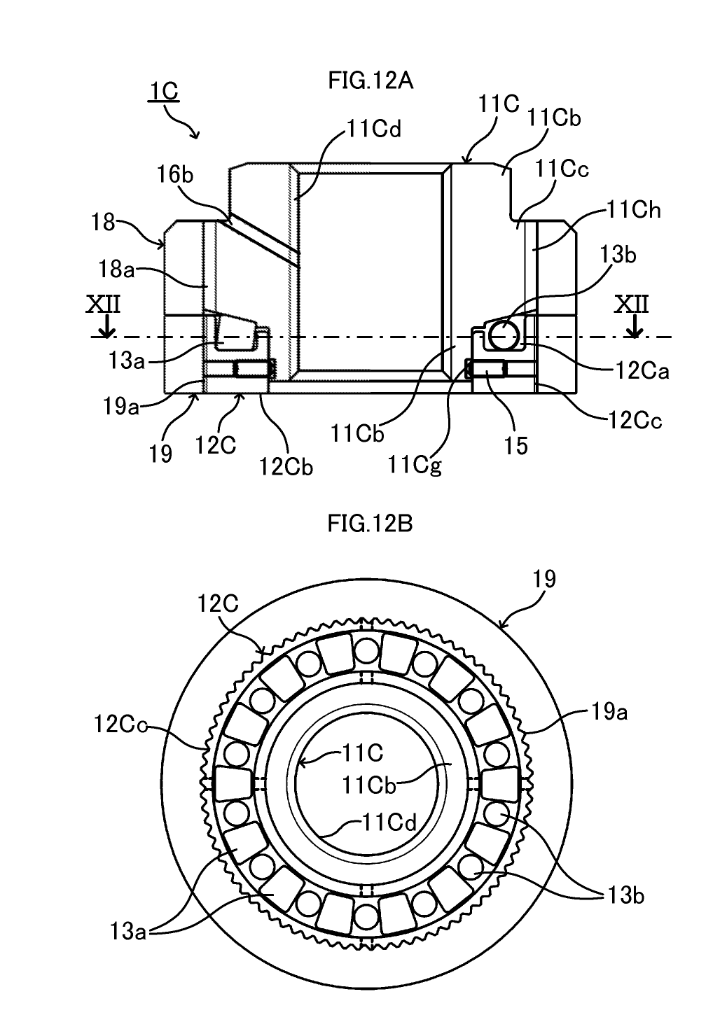

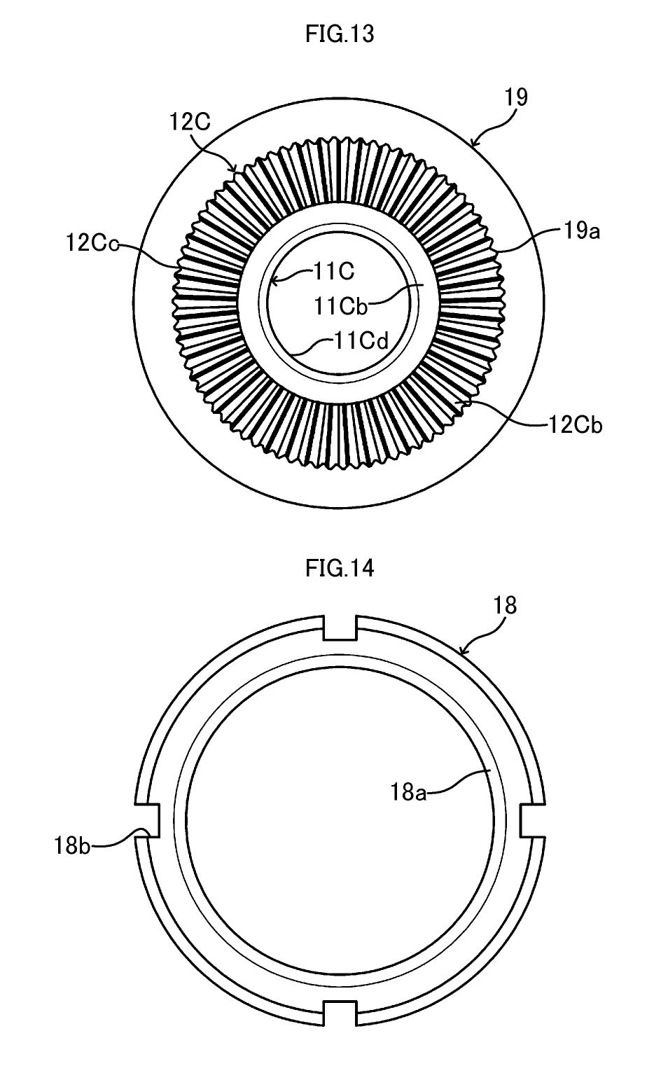

FIG. 10 is a front view showing the low torque nut 1C according to the second embodiment of the present invention. FIG. 11 is a top view showing the low torque nut 1C according to the second embodiment of the present invention. Further, FIG. 12A is a fragmentary sectional view taken along the line X-X in FIG. 11, and FIG. 12B is a fragmentary sectional view taken along the line XII-XII in FIG. 12A. Moreover, FIG. 13 is a bottom view showing the low torque nut 1C according to the second embodiment of the present invention.

As shown in FIGS. 10, 11, 12A, 12B and 13, in the low torque nut 1C according to the second embodiment, instead of the locking member 14 of the above-described first embodiment, a ring-shaped nut-side sleeve member 18 that is mounted on an outer periphery plane of a nut member 11C, and a ring-shaped saucer-side sleeve member 19 that is mounted on an outer periphery plane of a saucer member 12C are used. An outer diameter of the nut member 11C is provided as the same as an outer diameter of the saucer member 12C. Further, the nut-side sleeve member 18 and the saucer-side sleeve member 19 have an inner diameter corresponding to the outer diameter of the nut member 11C and the saucer member 12C, and an outer diameter of the nut-side sleeve member 18 is provided as the same as an outer diameter of the saucer-side sleeve member 19. Moreover, the height of the saucer-side sleeve member 19 is provided as the same as the height of the saucer member 12C. Both the nut member 11C and the saucer member 12C are comprised of metal materials that have intensities capable of sufficiently meeting fixing of the high intensity bolt 2 that generates a large axial force.

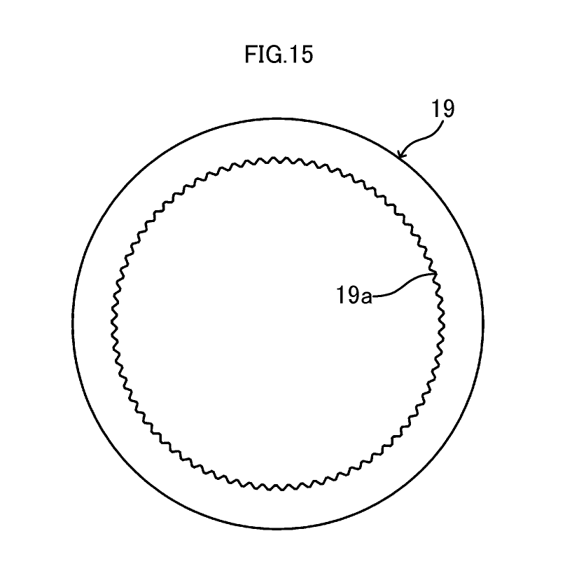

FIG. 14 is a top view showing the nut-side sleeve member 18 according to the second embodiment of the present invention, and FIG. 15 is a top view showing the saucer-side sleeve member 19 according to the second embodiment of the present invention.

An external thread groove 11Ch in a direction opposite to an inner periphery plane of a screwed runner 11Cd, is formed on an outer periphery plane of a flange portion 11Ca of the nut member 11C, and an internal thread groove 18a that is threadedly connected to the external thread groove 11Ch, is formed on an inner periphery plane of the nut-side sleeve member 18. That is to say, thread connection that is obtained by the external thread groove 11Ch and the internal thread groove 18a, functions as a reverse tap-thread with respect to the thread connection that is obtained by the thread groove 2a of the bolt 2 and the screwed runner 11Cd. Further, engagement portions 18b for being engaged with a tool used in tightening and loosening the nut-side sleeve member 18, are formed on an outer periphery plane of the nut-side sleeve member 18 at every equal angle interval (here, 90°). On the other hand, an engagement groove 19a that is engaged with a spline groove 12Cc of the outer periphery plane of the saucer member 12C, is formed on an inner periphery plane of the saucer-side sleeve member 19.

When tightening the low torque nut 1C according to the second embodiment, at first, as the same as the first embodiment, threadedly connecting the screwed runner 11d of the nut member 11 to the thread groove 2a of the bolt 2, manually turning in until the bottom 12b of the saucer member 12 contacts with the surface of the flange portion 4a of the tightening object 4, and tightening the nut member 11C up to a predetermined torque, a predetermined axial force and a predetermined angle by using a tightening tool such as a manual operation or a hydraulic torque wrench. Then, mounting the saucer-side sleeve member 19 on the saucer member 12 by engaging the engagement groove 19a of the saucer-side sleeve member 19 with the spline groove 12Cc of the saucer member 12C, and at the same time, threadedly connecting the internal thread groove 18a of the nut-side sleeve member 18 to the external thread groove 11Ch of the nut member 11C, and tightening the nut-side sleeve member 18 until a bottom of the nut-side sleeve member 18 takes a seat at a top surface of the saucer-side sleeve member 19.

On the other hand, when loosening the low torque nut 1C according to the second embodiment, at first, loosening the nut-side sleeve member 18 and dismounting the nut-side sleeve member 18 from the nut member 11C, and then, dismounting the saucer-side sleeve member 19 from the saucer member 12C. Subsequently, loosening the nut member 11C by using the tightening tool such as the manual operation or the hydraulic torque wrench. In this case, in the case that due to aging, the friction of the contact face between the thread groove 2a and the screwed runner 11d is large, just like the first embodiment, loosening the nut member 11C after injecting the lubricants through the lubricant injection holes 16a, 16b and 16c.

According to the low torque nut 1C relating to the second embodiment that is comprised of such a structure, it is possible to obtain operations, functions and effects that are the same as the above-described first embodiment, in addition, by the nut-side sleeve member 18 and the saucer-side sleeve member 19, it is possible to prevent an occurrence of strains caused by the rolling elements 13a and 13b, aging changes of a contact seat surface between the nut member 11C and the saucer member 12C and so on, and it is possible to avoid the degradation of the axial force. Therefore, it is possible to sufficiently meet even with respect to heavy load bolts applied to connecting portions such as a turbine, a feed-water pump and a compressor. Further, since thread connection of the nut-side sleeve member 18 and the nut member 11C is in a direction opposite to thread connection of the nut member 11C and the bolt 2, it is possible to realize a reliable anti-loosening.

Hereinbefore, although the embodiments of the present invention are described in detail, the present invention is not limited to the above-described embodiments, it will be appreciated that various modifications to the above-described embodiments are possible without departing from the scope of the present invention.

According to the low torque nut of the present invention, the nut member that a rotation torque is given through the tightening tool, does not directly contact with the tightening object, and then the saucer member that is rotatably fixed to the nut member through the rolling elements contacts with the seat surface of the tightening object. In this way, since it is possible to considerably reduce a necessary torque for the tightening and the loosening as compared to conventional nuts, it is possible to easily generate a large axial force by a small torque to fasten, and since it is possible to realize a speed-up and a laborsaving of the tightening and the loosening works, it is possible to make a great improvement even in a safety aspect.

Concretely, according to trial calculations of the applicant of the present invention, the low torque nut according to the present invention can obtain an effective torque value of five or more times in tightening with respect to the conventional torque control methods. Therefore, since the low torque nut according to the present invention can generate a large axial force with respect to the bolt, in the case of applying to high-intensity joint portions that a high fastening force caused by a large axial force is required such as a primary system valve of a nuclear power plant, an electric power turbine, a feed-water pump and a compressor, or connecting portions such as a large-size construction machine that dividing when moving and conveying and setting up in the field are required, a tower crane and support pillars of the building structures, the low torque nut according to the present invention is very useful.

Further, in the low torque nut according to the present invention, even in loosening, since the nut member functions as a rotatable structure without contacting with the seat surface of the tightening object, it is possible to quickly carry out works without damaging the seat surface of the tightening object.

Moreover, according to the low torque nut of the present invention, threadedly fixing the locking member in a state of engaging the locking member with the spline groove formed on the outer periphery plane of the saucer member so that the nut member does not rotate after fastening the nut member to the bolt. In this way, since it is possible to prevent a return rotation (i.e. loosening rotation) of nut caused by vibrations and so on, it is possible to realize improvement of reliability.

What is claimed is:

1. A low torque nut that is mounted to a thread groove of a bolt connecting to a tightening object, comprising:
a nut member that a screwed runner threadedly connecting to said thread groove is formed on an inner periphery plane, a predetermined shape engagement portion for being engaged with a tightening tool is formed on a top surface, and a plurality of position fixing screwed runners are drilled from an outer periphery plane toward an inner diameter direction;
a ring-shaped saucer member being rotatably mounted in a lower portion of said nut member that a non-slip plane is formed on a bottom in contact with said tightening object, and position fixing spline grooves are formed on an outer periphery plane along an axial direction at equal angle intervals;
a plurality of rolling elements that lie within a contact portion in an axial direction between said nut member and said saucer member; and
a locking member that has an engagement groove being engaged with said spline groove and a screw inserting hole that a screw threadedly connecting to said position fixing screwed runner of said nut member is inserted into,
wherein said locking member is fixed to said position fixing screwed runner of said nut member by said screw in a state of engaging said engagement groove with said spline groove after said nut member is fastened.

2. A low torque nut according to claim 1, wherein said position fixing screwed runner is drilled in at least four places along said outer periphery plane of said nut member at equal angle intervals.

3. A low torque nut that is mounted to a thread groove of a bolt connecting to a tightening object, comprising:
a nut member that a screwed runner threadedly connecting to said thread groove is formed on an inner periphery plane, a predetermined shape engagement portion for being engaged with a tightening tool is formed on a top surface, and an external thread groove in a direction opposite to said thread groove is formed on an outer periphery plane;
a ring-shaped saucer member being rotatably mounted in a lower portion of said nut member that a non-slip plane is formed on a bottom in contact with said tightening object, and position fixing spline grooves are formed on an outer periphery plane along an axial direction at equal angle intervals;
a plurality of rolling elements that lie within a contact portion in an axial direction between said nut member and said saucer member;
a ring-shaped nut-side sleeve member that an internal thread groove threadedly connecting to said external thread groove is formed on an inner periphery plane; and
a ring-shaped saucer-side sleeve member having a same height as said saucer member and a same outer diameter as said nut-side sleeve member that an engagement groove being engaged with said spline groove is formed on an inner periphery plane,
wherein after said nut member is fastened, said saucer-side sleeve member is mounted on said saucer member in a state of engaging said engagement groove with said spline groove, and said internal thread groove of said nut-side sleeve member is threadedly connected to said external thread groove, said nut-side sleeve member is tightened until a bottom of said nut-side sleeve member takes a seat at a top surface of said saucer-side sleeve member.

4. A low torque nut according to claim 3, wherein thread connection between said external thread groove of said nut member and said internal thread groove of said nut-side sleeve member is in a direction opposite to thread connection between said thread groove of said bolt and said screwed runner of said nut member.

5. A low torque nut according to claim 1, wherein said nut member is provided with a lubricant injection hole that is drilled to said screwed runner of an inner periphery plane in a radial direction from an outer surface.

6. A low torque nut according to claim 1, wherein
said nut member is provided with a plurality of lubricant injection holes that are drilled to said screwed runner of an inner periphery plane in a radial direction from an outer surface, and
said plural lubricant injection holes are set to a difference angle each other with respect to said inner periphery plane respectively.

7. A low torque nut according to claim 1, wherein said rolling elements are disposed within a concave groove formed on a top surface of said saucer member along a circumferential direction.

8. A low torque nut according to claim 1, wherein said rolling elements are comprised of a plurality of rollers with a conic trapezoidal shape and a plurality of steel spheres with a spherical shape that are disposed in each gap between said plurality of rollers.

9. A low torque nut according to claim 1, wherein said rolling elements are a plurality of rollers with a conic trapezoidal shape.

10. A low torque nut according to claim 1, wherein said rolling elements are a plurality of steel spheres with a spherical shape.
